(19) United States
(12) Patent Application Publication
(10) Pub. No.: US 2012/0136758 A1
(43) Pub. Date: May 31, 2012

(54) PRODUCTION MANAGEMENT WITH MULTI-TYPE KANBAN MODELING

(75) Inventors: Manuel Parente, Williston, VT (US); Ulrich B. Schimpel, Richterswil (CH); Satyadeep Vajjala, South Burlington, VT (US)

(73) Assignee: INTERNATIONAL BUSINESS MACHINES CORPORATION, Armonk, NY (US)

(21) Appl. No.: 12/957,003

(22) Filed: Nov. 30, 2010

(51) Int. Cl. G06Q 10/00

(52) U.S. Cl. 705/28

(57) ABSTRACT

Setting a plurality of reorder points for a plurality of products, the plurality of reorder points including a first reorder point and a second reorder point, the second reorder point greater than the first reorder point. Determining for one or more products, issuing one or more normal kanbans and one or more build ahead kanbans over one or more periods of time based on inventory levels and product demand. Approving for production in the current time period the one or more normal kanbans issued for the current time period. Determining if excess capacity exists to produce additional kanbans and approving for production in the current time period one or more of the build ahead kanbans in response to determining that excess capacity exists.

### BACKGROUND

The present invention relates generally to production management and more specifically to production management with multi-type kanban modeling.

Originally, the semi-conductor industry used push-based production planning which maximized the utilization of the very expensive tools and machines required to produce the semi-conductor components. The drawback of this push-based production is a lack of focus on customer demand. Thus, some of the expensive chips would pile up in a “lot” of inventory while the customer demand for other chips could not be satisfied. The move from a push-based to pull-based production enhances the customer service level. However, a high utilization of the machines and tools is now a problem. There exist times with peak demand and delays due to capacitated resources, and other times of low demand when the utilization is low.

Today many industries, such as the semi-conductor industry, require highly complex production processes. Their objectives to meet customer service levels and to optimally utilize capacitated resources is obstructed by unpredictable influences like the variability in demand, yield factors, bill of material (BOM) factors, lead time, and production time. In order to efficiently manage and control the complex production process they employ Lean principles. A substantial element of Lean is the replenishment of stock with kanbans.

Kanbans provide product details related to customer orders and are used to control production of new parts to supplement customer-initiated demand. As customer demand reduces inventory, a new kanban is issued which generates additional production in order to fulfill customer demand. Although the kanban system accounts for customer demand, resource capacity is not a factor therefore traditional kanban systems respond to demand fluctuations by either creating excess production capacity as the demand reduces, or by delaying production because of excessive demand as the demand increases.

### SUMMARY

An embodiment is a computer implemented method for managing production in a multi kanban environment. The method includes setting, on a computer, a plurality of reorder points for a plurality of products, the plurality of reorder points comprising a first reorder point and a second reorder point, the second reorder point greater than the first reorder point. The method further includes determining, on the computer, demand for one or more of the plurality of products over a plurality of time periods and determining, on the computer, an inventory level of the one or more of the plurality of products over the plurality of time periods in response to determining the demand. The method further includes issuing, on the computer, one or more normal kanbans for one or more of the plurality of time periods in response to determining that the inventory level of one or more of the plurality of products is below the first reorder point, the one or more of the plurality of time periods including a current time period, and issuing, on the computer, one or more build ahead kanbans for the one or more of the plurality of time periods in response to determining that the inventory level of one or more of the plurality of products is below the second reorder point but above the first reorder point. The method further includes approving, on the computer, for production in the current time period the one or more normal kanbans issued for the current time period, determining, on the computer, if excess capacity exists to produce additional kanbans and approving, on the computer, for production in the current time period one or more of the one or more build ahead kanbans in response to determining that excess capacity exists.

Another embodiment is a system for managing production in a multi kanban environment including a modeler module and a capacity manager module. The modeler module is for setting a plurality of reorder points for a plurality of products, the plurality of reorder points comprising a first reorder point and a second reorder point, the second reorder point greater than the first reorder point. The modeler module further determining demand for one or more of the plurality of products over a plurality of time periods, determining an inventory level of the one or more of the plurality of products over the plurality of time periods in response to determining the demand, and issuing one or more normal kanbans for one or more of the plurality of time periods in response to determining that the inventory level of one or more of the plurality of products is below the first reorder point, the one or more of the plurality of time periods including a current time period. The modeler additionally issuing one or more build ahead kanbans for the one or more of the plurality of time periods in response to determining that the inventory level of one or more of the plurality of products is below the second reorder point but above the first reorder point. The capacity manager module is communicatively coupled to the modeler module and is for approving for production in the current time period the one or more normal kanbans issued for the current time period. The capacity manager module also determines if excess capacity exists to produce additional kanbans; and approves for production in the current time period one or more of the one or more build ahead kanbans in response to determining that excess capacity exists.

A further embodiment is a computer program product for managing production in a multi kanban environment, the computer program product including a tangible storage medium readable by a processing circuit and storing instructions for performing a method. The method includes setting, on a computer, a plurality of reorder points for a plurality of products, the plurality of reorder points comprising a first reorder point and a second reorder point, the second reorder point greater than the first reorder point. The method further includes determining, on the computer, demand for one or more of the plurality of products over a plurality of time periods and determining, on the computer, an inventory level of the one or more of the plurality of products over the plurality of time periods in response to determining the demand. The method further includes issuing, on the computer, one or more normal kanbans for one or more of the plurality of time periods in response to determining that the inventory level of one or more of the plurality of products is below the first reorder point, the one or more of the plurality of time periods including a current time period, and issuing, on the computer, one or more build ahead kanbans for the one or more of the plurality of time periods in response to determining that the inventory level of one or more of the plurality of products is below the second reorder point but above the first reorder point. The method further includes approving, on the computer, for production in the current time period the one or more normal kanbans issued for the current time period, determining, on the computer, if excess capacity exists to produce additional kanbans and approving, on the computer, for production in the current time period one or more of the one or more build ahead kanbans in response to determining that excess capacity exists.

Additional features and advantages are realized through the techniques of the present embodiment. Other embodiments and aspects are described herein and are considered a part of the claimed invention. For a better understanding of the invention with the advantages and features, refer to the description and to the drawings.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a block diagram of a system for multi-type kanban processing in accordance with an embodiment;

FIG. 2 illustrates a block diagram of the components of a system for multi-type kanban processing in accordance with an embodiment;

FIG. 3A illustrates a demand schedule for a product A in an embodiment;

FIG. 3B illustrates a demand schedule for a product B in an embodiment;

FIG. 3C illustrates a combined demand schedule for the products A and B in an embodiment;

FIG. 4A illustrates a combined demand schedule for the products A and B with based on FIFO processing in an embodiment;

FIG. 4B illustrates a combined demand schedule for the products A and B with an increased priority for product B in an embodiment;

FIG. 4C illustrates a combined demand schedule for the products A and B with an increased priority for product B starting in period two in an embodiment;

FIG. 5 illustrates a process flow for selecting a second reorder point for a product in an exemplary embodiment;

FIG. 6 illustrates a process flow of a production capacity and order management system using a second reorder point in an embodiment;

FIG. 7A illustrates a production schedule for products A and B using a build-ahead reorder point for product B as depicted in an embodiment;

FIG. 7B illustrates a production schedule for products A and B using a build-ahead reorder point for products A and B as depicted in an additional embodiment;

FIG. 8 illustrates a block diagram of a kanban queue system in an embodiment;

FIG. 9 illustrates a process flow of a production capacity and order management system using a second reorder point and an emergency reorder point in an embodiment;

FIG. 10 illustrates a process flow for managing excess demand in an embodiment;

FIG. 11 illustrates a propagation of replenishment orders to a supplier by means of a production and propagation manager in an exemplary embodiment;

FIG. 12A illustrates demand and supply for orders of product bundles or co-products in an embodiment;

FIG. 12B illustrates demand and supply for orders of product bundles or co-products in an additional embodiment;

FIG. 12C illustrates demand and supply for orders of more complex product bundles or co-products in a further embodiment; and

FIG. 13 illustrates a process flow for orders comprising product bundles or co-products in an embodiment.

### DETAILED DESCRIPTION

In a production planning environment the optimal balance between maximizing production capacity while minimizing excessive production and meeting customer demand requires a balance between a push methodology of producing at full capacity, and the pull on specific parts created by customer demand.

In one embodiment, maximizing capacity is balanced with fulfilling customer demand by modeling customer demand in which shapes kanban fulfillment in order to meet demand while maximizing the available capacity. In one embodiment the fulfillment shaping is preformed by implementing one or more of: building kanbans ahead of time based on anticipated demand; implementing prioritization in order to support emergency kanbans in case of an imminent stock-out situation; implementing multiple kanban types in order to support additional prioritization; introducing separate reorder points for each of the kanban types and priorities; temporarily adjusting and enabling the different reorder points; employing a Lean capacity manager that approves and assigns capacity according to the different priorities, types and waiting time of queued kanbans; extending the Lean capacity manager to complex product structures like product bundles (Co-Products) and optional sourcing paths; and propagating of the demand only according to the approved kanbans as opposed to the queued kanbans via realistic replenishment orders (referred to as flow policy) that take into account work in progress (WIP) and the virtual stock, for example.

Traditionally, deterministic multi-echelon enterprise resource planning (ERP)/material requirements planning (MRP) based planning and scheduling is used for production planning. An embodiment targets the planning for a manufacturing execution in a Lean environment. This optimizes customer service with minimum inventory investment and manufacturing cost through business processes that are consumption driven and aligned to end customer demand. The objectives of meeting customer service level and optimally utilizing capacitated resources is obstructed by influences like the variability in demand, yield factors, BOM factors, lead time, and production time. In order to efficiently manage and control the complex production process Lean principles are introduced. Lean principles of manufacture, however, focus on minimizing excess inventory and meeting customer demand, but do not favorably take into account maximizing capacity, nor are Lean principles targeted toward future peaks in demand which may outstrip capacity at a date in the future.

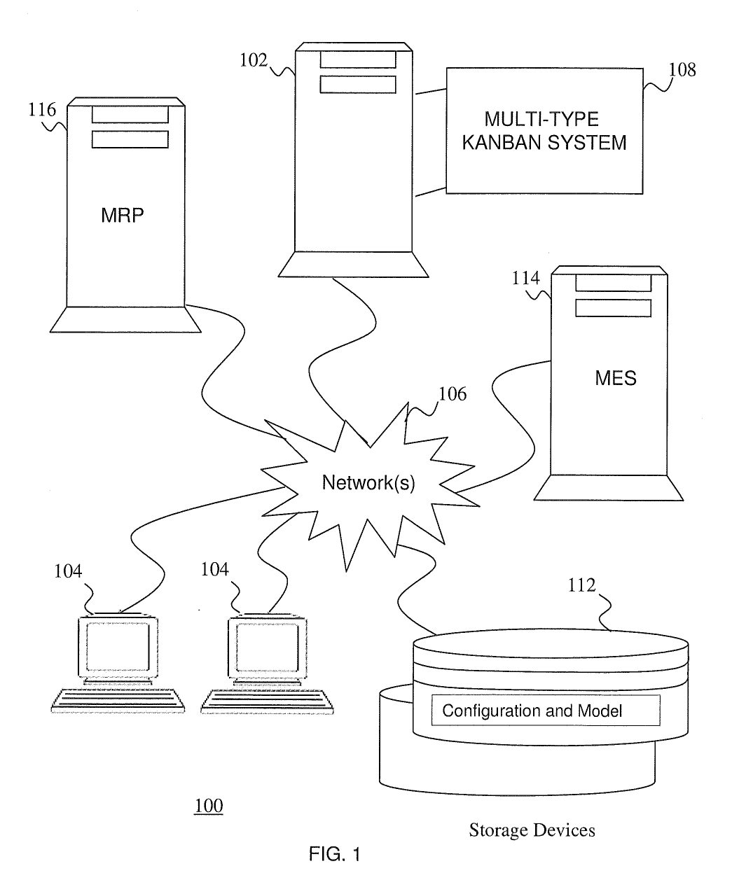

Turning now to FIG. 1, a system 100 for implementing multi-type kanban modeling and management will now be described. In an embodiment, the system 100 includes a host system computer 102 executing computer instructions for multi-type kanban modeling and management. Host system computer 102 may operate in any type of environment that is capable of executing a software application. Host system computer 102 may comprise a high-speed computer processing device, such as a mainframe computer, to manage the volume of operations governed by an entity for which the multi-type kanban modeling and management process is executing. In an embodiment, the host system computer 102 is part of an enterprise (e.g., a commercial business) that implements the multi-type kanban modeling and management.

In an embodiment, the system 100 includes a management resource planning system (MRP) 116. The MRP 116 executing computer instructions for inventory, demand and order management and planning. The MRP 116 may operate in any type of environment that is capable of executing a software application. In an embodiment, the MRP 116 may comprise a high-speed computer processing device, such as a mainframe computer, to manage the volume of operations governed by an entity for which the MRP 116 is executing. In an embodiment, the MRP 116 is communicatively coupled to a network 106. The MRP 116 is described as executing on a separate computer system for clarity, it would be understood by one of ordinary skill in the art that the MRP 116 may be executed on the host system computer 102, or any other computer device as is known in the art.

In an embodiment, the system 100 includes a manufacturing execution system (MES) 114. The MES 114 executing computer instructions for manufacturing planning and implementation. In an embodiment, the MES 114 is configured to operate and manage a Lean production environment. The MES 114 may operate in any type of environment that is capable of executing a software application. In an embodiment, the MES 114 may comprise a high-speed computer processing device, such as a mainframe computer, to manage the volume of operations governed by an entity for which the MES 114 is executing. In an embodiment, the MES 114 is communicatively coupled to the network 106. The MES 114 is described as executing on a separate computer system for clarity, it would be understood by one of ordinary skill in the art that the MES 114 may be executed on the host system computer 102, or any other computer device as is known in the art.

In an embodiment, the system 100 depicted in FIG. 1 includes one or more client systems 104 through which users at one or more geographic locations may contact the host system computer 102. The client systems 104 are coupled to the host system computer 102 via one or more networks 106. Each client system 104 may be implemented using a general-purpose computer executing a computer program for carrying out the processes described herein. The client systems 104 may be personal computers (e.g., a lap top, a personal digital assistant, a mobile device) or host attached terminals. If the client systems 104 are personal computers, the processing described herein may be shared by a client system 104 and the host system computer 102 (e.g., by providing an applet to the client system 104). Client systems 104 may be operated by authorized users (e.g., programmers) of the multi-type kanban modeling and management described herein.

The networks 106 may be any type of known network including, but not limited to, a wide area network (WAN), a local area network (LAN), a global network (e.g., Internet), a virtual private network (VPN), and an intranet. The networks 106 may be implemented using a wireless network or any kind of physical network implementation known in the art. A client system 104 may be coupled to the host system computer 102 through multiple networks (e.g., intranet and Internet) so that not all client systems 104 are coupled to the host system computer 102 through the same network. One or more of the client systems 104 and the host system computer 102 may be connected to the networks 106 in a wireless fashion. In one embodiment, the networks 106 include an intranet and one or more client systems 104 execute a user interface application (e.g., a web browser) to contact the host system computer 102 through the networks 106. In another embodiment, the client system 104 is connected directly (i.e., not through the networks 106) to the host system computer 102 and the host system computer 102 contains memory for storing data in support of multi-type kanban modeling and management. Alternatively, a separate storage device (e.g., storage device 112) may be implemented for this purpose.

In an embodiment, the storage device 112 includes a data repository with data relating to multi-type kanban modeling and management by the system 100, as well as other data/information desired by the entity representing the host system computer 102 of FIG. 1. The storage device 112 is logically addressable as a consolidated data source across a distributed environment that includes networks 106. Information stored in the storage device 112 may be retrieved and manipulated via the host system computer 102 and/or the client systems 104. In an embodiment, the storage device 112 includes one or more databases containing, e.g., multi-type kanban modeling and management data and corresponding configuration parameters, values, methods, and properties, as well as other related information as will be discussed more fully below. It will be understood by those of ordinary skill in the art that the storage device 112 may also comprise other structures, such as an XML file on the file system or distributed over a network (e.g., one of networks 106), or from a data stream from another server located on a network 106. In addition, all or a portion of the storage device 112 may alternatively be located on a client system 104.

The host system computer 102 depicted in the system of FIG. 1 may be implemented using one or more servers operating in response to a computer program stored in a storage medium accessible by the server. The host system computer 102 may operate as a network server (e.g., a web server) to communicate with the client systems 104. The host system computer 102 handles sending and receiving information to and from the client systems 104 and can perform associated tasks. The host system computer 102 may also include a firewall to prevent unauthorized access to the host system computer 102 and enforce any limitations on authorized access. For instance, an administrator may have access to the entire system and have authority to modify portions of the system. A firewall may be implemented using conventional hardware and/or software as is known in the art.

The host system computer 102 may also operate as an application server. The host system computer 102 executes one or more computer programs to provide multi-type kanban modeling and management. Computer system 102 includes a multi-type kanban system. As indicated above, processing may be shared by the client systems 104 and the host system computer 102 by providing an application (e.g., java applet) to the client systems 104. Alternatively, the client system 104 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

It will be understood that the execution of the multi-type kanban modeling and management processes and methods described in FIG. 1 may be implemented in hardware, software, or a combination thereof.

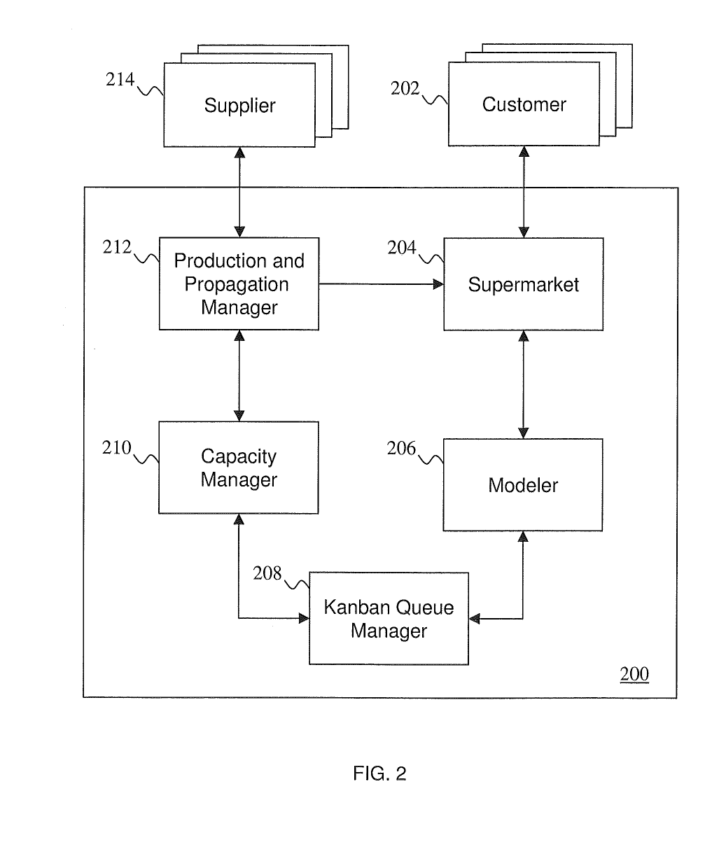

FIG. 2 illustrates a block diagram of a multi-type kanban modeling management system 200 (also referred to herein as “modeling system”) in accordance with an embodiment. In one embodiment the modeling system 200 is executed on the host system 102 of FIG. 1. The modeling system 200 includes a supermarket 204, the supermarket 204 serves as an inventory stock pile of complete products, virtual inventory and/or works in progress. In one embodiment the supermarket 204 contains inventory that has been or is anticipated to be ordered by one or more customers 202. In another embodiment, the supermarket 204 includes cumulative inventory, the cumulative inventory includes complete products, virtual inventory and works in progress. In one embodiment, the customer 202 is a wholesale establishment, which orders completed products suitable for resale. In another embodiment, the customer 202 is a manufacturer of components and/or subcomponents and orders components from the supermarket 204 to fulfill production requirements. The customer 202 has been described for purposes of clarity, it would be understood by one of ordinary skill in the art that the customer 202 could be any source of demand for inventory from the supermarket 204.

The modeling system 200 includes a modeler module 206. The modeler module 206 performs modeling of production, production requirements, and sales based on a number of factors including, the inventory level of the supermarket 204, WIP, production capacity, actual demand, anticipated demand, and other factors impacting production as are known in the art. In one embodiment, modeler module 206 calculates cumulative product demand based on actual demand, anticipated demand, and other factors as is known in the art. In one embodiment the modeler module 206 is communicatively coupled to the supermarket 204, a kanban queue manager 208 and other systems in the production environment. The modeler module 206 is depicted as communicatively coupled to the kanban queue manager and the supermarket in FIG. 2 for purposes of clarity, however, it will be understood by those of ordinary skill in the art that the modeler module 206 may be communicatively coupled to other modules both shown in FIG. 2, such as, for example, a capacity manager module 210, and a production and propagation manager module 212 as well as other modules and databases such as a production capacity database (not shown), a production staffing model (not shown) or any other data feed that may be used for generating production models.

In an embodiment, the modeling system 200 also includes a kanban queue manager 208. The kanban queue manager 208 collects kanbans of orders for a variety of components and coordinates the production of the kanbans. The modeling system 200 also includes a capacity manager module 210. In an embodiment the capacity manager module 210 determines the capacity constraints of the production environment based on current production and the kanbans that are in the kanban queue manager 208. In an embodiment, the capacity manager module 210 is communicatively coupled to the kanban queue manager 208 and a production and propagation manager module 212.

In an embodiment, the modeling system 200 includes a production and propagation manager module 212. In one embodiment the production and propagation manager module 212 is communicatively coupled to the capacity manager module 210 and the supermarket 204. In one embodiment the production and propagation manager module 212 generates replenishment orders for parts from one or more suppliers 214 based on the BOM by exploding the number of approved and produced kanbans which consider based on kanbans received by the capacity manager. The production and propagation manager module 212 is depicted as communicatively coupled to the capacity manager module 210 and the supermarket 204 in FIG. 2 for purposes of clarity, however, it will be understood by those of ordinary skill in the art that the production and propagation manager module 212 may be communicatively coupled to other modules both shown in FIG. 2, such as, for example, the kanban queue manager 208 as well as other modules and databases such as a production capacity database (not shown), an production staffing model (not shown) or any other data feed that may be used for determining production requirements.

In an embodiment physical kanban cards are exchanged between a supplier and consumer to replenish the consumed inventory. A kanban card (KA,_{X}) represents an order signal for a material A of a certain order quantity X. The consumer issues KA,_{X} e.g. when the virtual stock S falls below a certain level R, often referred to as a reorder point. Each product has a reorder point, and as each product's inventory drops to or below the reorder point kanbans are issued for that product. The supplier collects these kanbans from his N consumers (C₁, C₂, . . . , C_{N}) for different materials (e.g. A and B). The supplier feeds its production process according to the sequence of arriving kanbans. This corresponds to a FIFO principle for KA,_{X} and KB,_{X} from all N consumers.

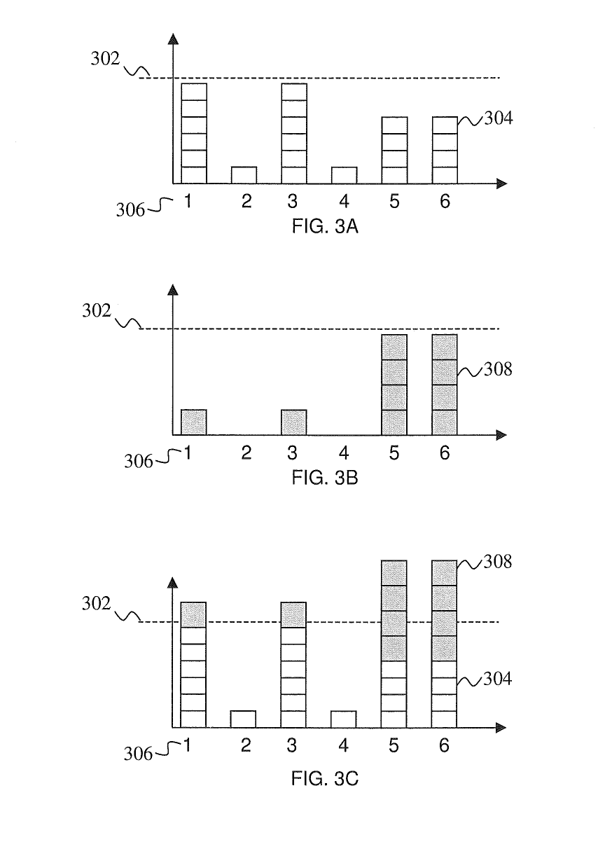

FIGS. 3A and 3B depict a set consolidated order queues in an exemplary embodiment. FIG. 3A illustrates a consolidated order queue of product A kanbans 304. The production capacity 302 indicates the maximum capacity of the production environment. The product A kanbans 304 are spread along the x-axis to indicate the required delivery schedule 306 that is required in order meet the customer SLA's. In an embodiment, the x-axis is the number of days from today that a product A must be manufactured in order to meet all SLAs for the product A kanbans 304. For example, FIG. 3A illustrates that 6 product A kanbans 304 are required in 1 day, 1 product A kanban 304 is required in 2 days, etc.

Similarly, FIG. 3B illustrates a consolidated order queue of product B kanbans 308 in an embodiment. The production capacity 302 indicates the maximum capacity of the production environment. The product B kanbans 308 are spread along the x-axis to indicate the required delivery schedule 306 that is required in order meet the customer SLA's. In an embodiment, the x-axis is the number of days from today that a product B kanban 308 must be manufactured in order to meet all SLAs for the product B kanban 308. For example, FIG. 3B illustrates that 1 product B kanban 308 is required in 1 day, 0 product B kanbans 308 are required in 2 days, etc.

FIG. 3C illustrates the combined order queues for product A kanbans 304 and product B kanbans 308 in an embodiment. The demand for products is often “bulky” and does not occur in a constant rate. Due to restrictions of production capacity 302 some kanban requests have to be delayed in peak times. For example, at days 1 and 3 of FIG. 3C the number of product kanbans required is beyond the production capacity 302 of the production environment.

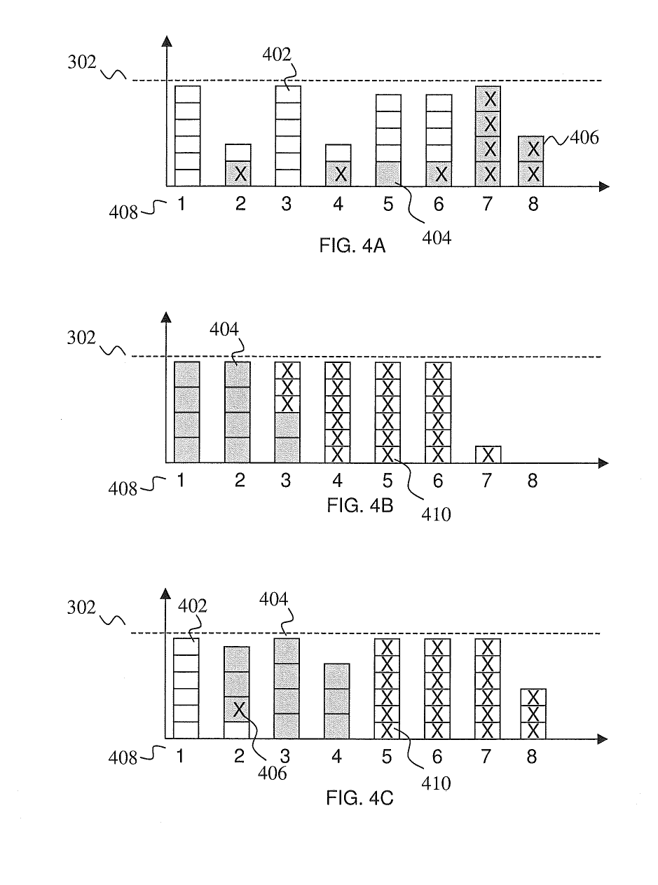

FIG. 4A illustrates one method of managing kanbans in order to maintain in production below the production capacity 302. In FIG. 4A the kanbans are processed in a first in first out (FIFO) manner. In this way all of the product A kanbans 402 are produced, and a product B kanban 404 is produced on schedule. The FIFO principles, however, still result in reduced service levels because of delayed product B kanbans 406. The delayed product B kanbans 406 (depicted with an X) are produced according to the FIFO schedule 408 which occurs after the required delivery schedule 306 of FIGS. 3A and 3B. Although a number of delayed orders exist in days 4-8, days 2, and 4-6 have excess capacity, which remains unused.

FIG. 4B illustrates one method of increasing the utilization of production capacity. The method of FIG. 4B is to prioritize and anticipate all of the product B kanbans 404 thereby causing the product B kanbans 404 to be produced ahead of the product A kanbans 410. Although the product B kanbans 404 are now produced according to their service levels, the product A kanbans 410 are now delayed (depicted by X's) and therefore none of the product A kanbans meet the required service levels.

FIG. 4C illustrates a combined demand schedule for the products A and B with an increased priority for product B starting in period two in an embodiment. The method depicted in FIG. 4C increases a reorder level R of product B at time T. However, this method simply increases the demand unnecessarily from time T onwards because the “real” demand is less then indicated by the increased value of R. This causes a possible peak demand at the beginning of T. This build ahead method results in a slightly better SLA for product A kanbans 402 and a slightly worse SLA for product B kanban 404. This method, however still results in delayed product A kanbans 410 (depicted with an X) and a delayed product B kanban 406. In the example of FIG. 4B and FIG. 4C, T is equal to 1 and 2, respectively.

FIGS. 3A-3C and 4A-4C show that using Lean manufacturing alone, even with small variations in priorities, will not maximize production capacity, and often will result in a missing a number of SLAs based on the unevenness of demand.

In one embodiment, a second reorder point is applied to each of the products. The second reorder point (R_{BA}) is selected such that the first reorder point (R)<=R_{BA}. In one embodiment, kanbans that are issued because stock is below R are referred to as “normal kanbans.” Kanbans issued because the stock is below R_{BA} are called “build-ahead Kanbans.”

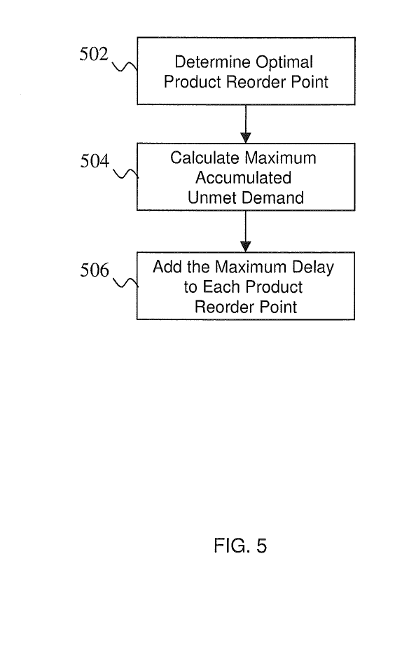

FIG. 5 illustrates a process flow for selecting R_{BA} for a product in an exemplary embodiment. In one embodiment, the process flow for selecting the R_{BA} is executed on the host system 102 of FIG. 1. In additional embodiments, the process flow for selecting R_{BA} is executed at the modeler module 206 of FIG. 2. At block 502 the optimal reorder point R for each of the products A and B (R_{A} and R_{B} respectively) are determined. In one embodiment the R_{A} and R_{B} are selected such that a minimum stock is maintained in the supermarket 204 of FIG. 2. In additional embodiments, factors such as product lead times, production time, and capacity including the variability of each of these factors are used to calculate R_{A} and R_{B} as is known in the art. At block 504 the maximum number of accumulated, unmet demand over a period of time (maximum delay) in units is calculated. In an embodiment the maximum delay can be calculated by modeling, on the modeler module 206 of FIG. 2 anticipated and actual demand while factoring in production capacity. By combining the current and backlogged demand with production capacity, the modeler module 206 determines days in which demand exceeds production capacity for each product. In one embodiment, the modeler module 206 determines a maximum delay for each product by modeling the production capacity of all products in the production environment based on all product demand for all of the products simultaneously. By factoring in all of the capacity constraints of all of the products simultaneously, the maximum output capacity of the production environment is determined. Based on this maximum output capacity, the maximum delay over a period of time T for each product (also referred to herein as MAX) is determined. In one embodiment the MAX for each product is the peak of current and already backlogged demand in units during T that cannot be met based on the capacity constraints of the production environment. Returning to the example above, in an environment with two products A and B, A_{MAX} and B_{MAX} are determined. At block 506, the second reorder point R_{BA} for each product is calculated by adding the MAX for each product to the first reorder point R for each product.

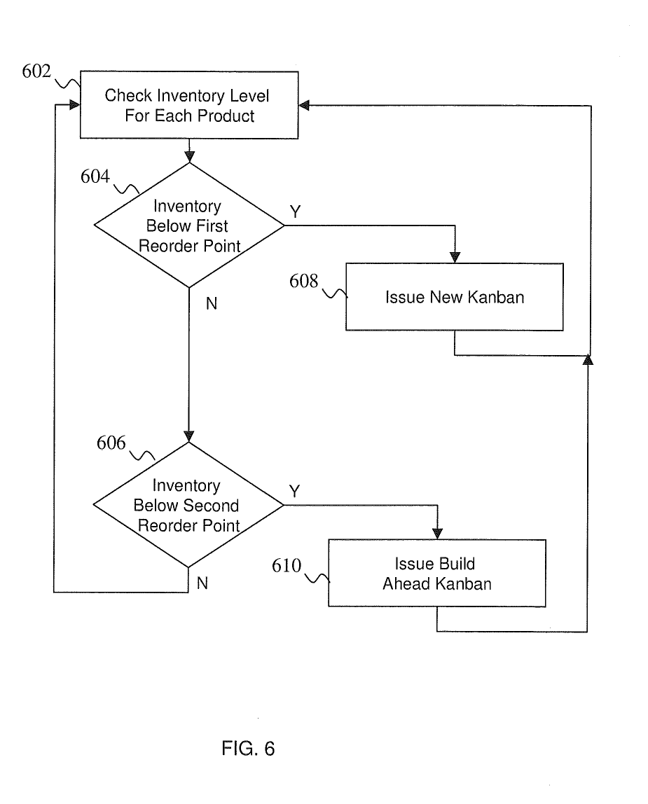

FIG. 6 illustrates a process flow of a production capacity and order management system using a second reorder point in an embodiment. In one embodiment the process flow of FIG. 6 is executed on the host system 102 of FIG. 1. At block 602, for each product in the supermarket 204, the inventory count is determined. In one embodiment, the current inventories are stored in a database in a storage device, such as storage device 112 of FIG. 1. In another embodiment the supermarket 204 maintains records of inventory either in stock or in transit or a combination of the two. At block 604, once the stock level for a product is determined, the stock level is compared to the first reorder point R, for the product. If the stock level is below R for the product, at block 608, additional kanbans are created equaling a quantity that will replenish stock to the above R for the product. The additional kanbans are then submitted to the kanban queue manager 208 and processing begins again at block 602. In an embodiment, the number of additional kanbans may be influenced by a number of restrictions such as the number of kanbans on hand, the maximum number of kanbans that are allowed to be issued per period, and other restriction as are known in the art. Returning to block 604, if the inventory is not below the first reorder point, the inventory is compared to R_{BA} for the product. At block 610, if the inventory is below the R_{BA} for the product, one or more build ahead kanbans are created equaling a quantity that will replenish stock above R_{BA} and they are submitted to the kanban queue manager 208 and processing begins again at block 602. Returning to block 606, if inventory for the product is above R_{BA} then processing proceeds to block 602 and the process continues taking into account new orders, capacity, and any other factor that may affect production output as is known in the art. In one embodiment, the process flow described above is repeated for each product in supermarket. In another embodiment the process flow is executed for all products simultaneously.

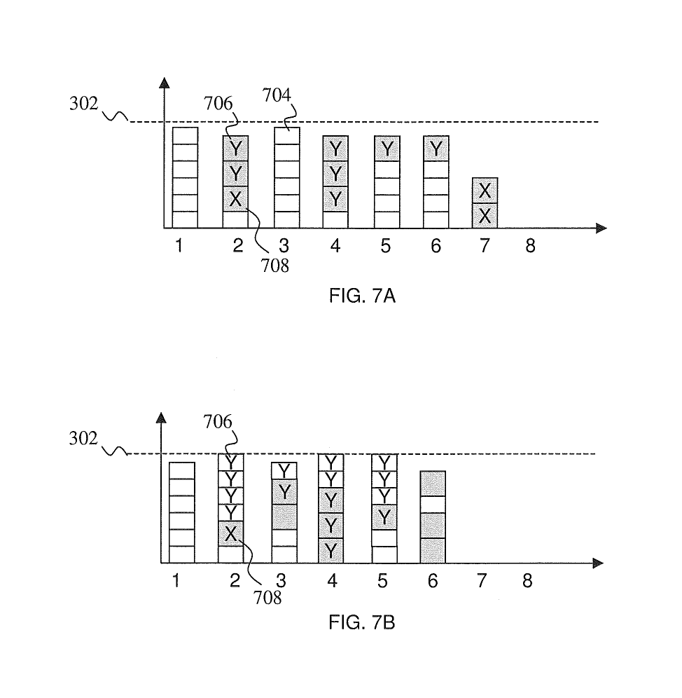

FIG. 7A illustrates the production schedule for products A and B using a build-ahead reorder point for product B as depicted in FIGS. 3A-3C after execution of the process flow described above with regard to FIG. 6 in an embodiment. In the example depicted in FIG. 7A R_{BA,A} equals R_{A} because the production environment is capable of supporting production of all of the kanbans for A with the normal reorder point R_{A}. The R_{BA,B} is R_{B}+6 because at days 5 and 6 there is an excess demand of each 3 units of product B as depicted in FIG. 3C which accumulate to 6 units of excess demand by the end of period 6. As orders are received, the product B build ahead kanbans 706 (depicted with a Y) are received by the kanban queue manager 208 and are processed where excess capacity is determined to exist in days 2, and 4-6. Although the addition of the second reorder point has substantially improved the SLA for product B over the embodiments of FIGS. 4A-4C, there are still a number of delayed kanbans 708 (depicted with an X). In further embodiments described below, additional gains in SLAs can be achieved.

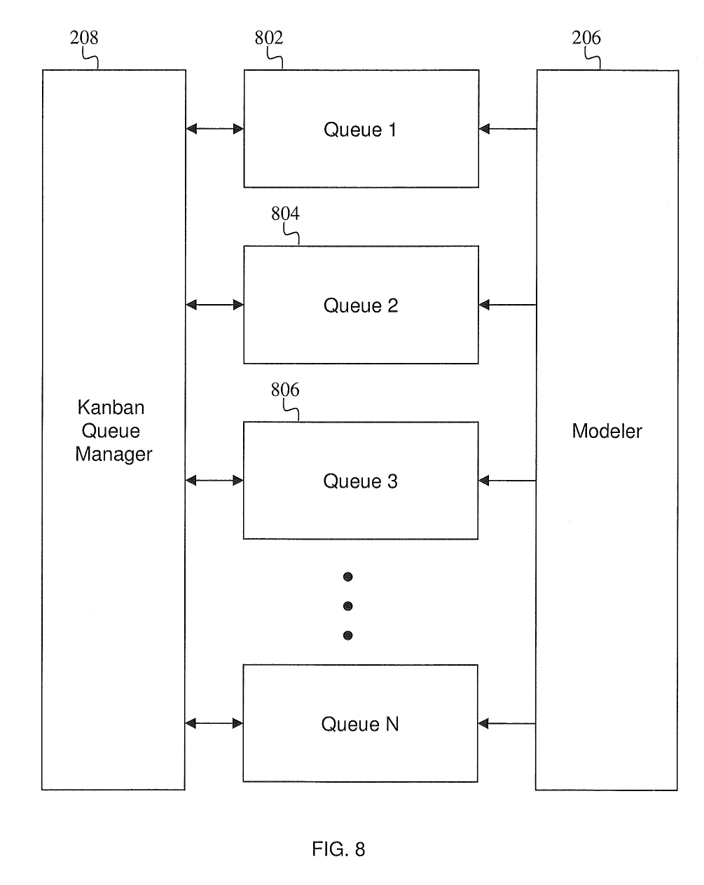

In one embodiment, a production priority is established wherein each kanban, or group of kanbans, is given a priority. In one embodiment, the kanbans generated as a result of inventory falling below R are given a priority of 2, and any kanbans that are produced as a result of inventory falling below R_{BA} are given a priority of 3. FIG. 8 illustrates a kanban queue in an embodiment. In one embodiment the modeler module 206 generates kanbans based on R and places them in queue 2 804. The modeler places kanbans generated based on R_{BA} in queue 3. The kanban queue manager 208 processes kanbans scheduled for each day from the queues of highest priority (i.e. the lowest numbered queue) and, once all of the kanbans in the queue that are scheduled for that day are processed, moves on to process kanbans from the next highest priority queue. The process continues until all either all kanbans for the day are completed, or the processing capacity for the day has been exhausted. FIG. 8 illustrates additional queues such as queue 1 802, however, the number and labeling of queues is provided merely as examples for purposes of clarity. Those of ordinary skill in the art will understand that any number of additional queues may be used in order to create additional priority levels. In addition, higher priority queues can be added as will be described in more detail below. Although FIG. 8 illustrates a queue data structure for purposes of clarity, it will be understood by those of ordinary skill in the art that other data structures and mechanisms may be used to implement the priority function described herein.

FIG. 7B illustrates the production schedule for products A and B using a build-ahead reorder point for products A and B as depicted in FIGS. 3A-3C after execution of the process flow described above with regard to FIG. 6 in an embodiment. The addition of the priority to each of the kanbans allows build ahead kanbans 706 both product A and product B (depicted with an A) to be produced on days with excess capacity, such as day 2 of FIG. 7B. By processing kanbans as described above, both SLA's and capacity is maximized.

Although R_{BA} has been described above as a second reorder point, in an additional embodiment, the R_{BA} can be eliminated when excess demand has been met and no unmet demand is projected. In one embodiment, R_{BA} for products which have no anticipated unmet demand are set equal to R. When R_{BA} is set equal to R for a product no build ahead kanbans are produced and only the current day's demand is produced. In the embodiment depicted in FIG. 7A, R_{BA} for product A was set equal to R and therefore no build ahead kanbans were produced.

At times stock levels of certain items may be reduced to levels that jeopardize SLAs. Where stock levels drop quickly, or where a buffer of stock is required to fulfill orders, the set of reorder points discussed above may not be sufficient to meet the additional demand. In one embodiment kanbans may be created at one or more higher priorities than the normal kanbans. In one embodiment a third reorder point R_{E} is established wherein R_{E}<R<R_{BA}.

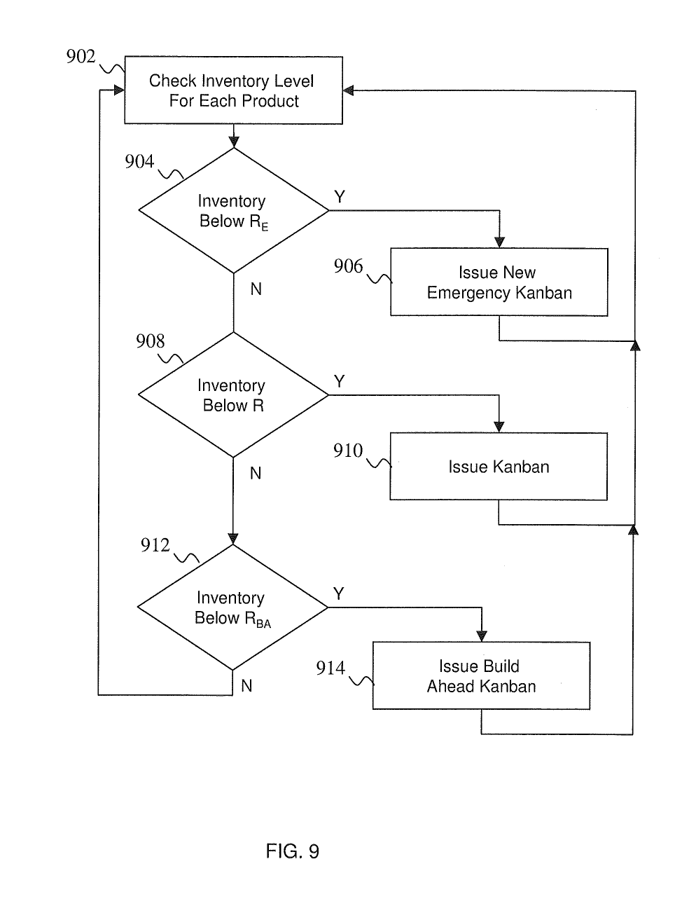

FIG. 9 illustrates a process flow of a production capacity and order management system using a second reorder point and an emergency reorder point in an embodiment. In one embodiment the process flow of FIG. 9 is executed on the host system 102 of FIG. 1. At block 902, for each product in the supermarket 204, the inventory count is determined. In one embodiment, the current inventories are stored in a database in a storage device, such as storage device 112 of FIG. 1. In another embodiment the supermarket 204 maintains records of inventory either in stock or in transit or a combination of the two. At block 904 once the stock level for a product is determined, the stock level is compared to the emergency reorder point R_{E}, for the product. If the stock level is below R_{E} for the product, additional kanbans are created equaling a quantity that will replenish stock to the above R_{E} for the product and the kanban priority is set to 1. In an embodiment, the number of additional kanbans may be influenced by a number of restrictions such as the number of kanbans on hand, the maximum number of kanbans that are allowed to be issued per period, and other restriction as are known in the art. The additional kanbans are then submitted to the kanban queue manager 208 in queue 1 802 of FIG. 8 and processing begins again at block 902.

Returning to block 904, if the inventory is not below R_{E}, the inventory is compared to R for the product at block 908. If the stock level is below R for the product, at block 910, additional kanbans are created equaling a quantity that will replenish stock to the above R for the product and their priority is set to 2. The additional kanbans are then submitted to the kanban queue manager 208 in queue 2 804, and processing begins again at block 902. Returning to block 908, if the inventory is not below the first reorder point, the inventory is compared to R_{BA} for the product at block 912. At block 912, if the inventory is below the R_{BA} for the product, build ahead kanbans are created equaling a quantity that will replenish stock above R_{BA} and their priority is set to 3. The build ahead kanbans are submitted to the kanban queue manager 208 in queue 3 806 of FIG. 8 at block 914, and processing begins again at block 902. Returning to block 912, if inventory for the product is above R_{BA} then processing proceeds to block 902 and the process continues taking into account new orders, capacity, and any other factor that may affect production output as is known in the art. In one embodiment, the process flow described above is repeated for each product in supermarket. In another embodiment the process flow is executed for all products simultaneously.

In additional embodiments, even with the methods listed above, capacity constraints in the production system may not be sufficient to handle all customer demand. In these situations additional management and selection of the kanbans is required.

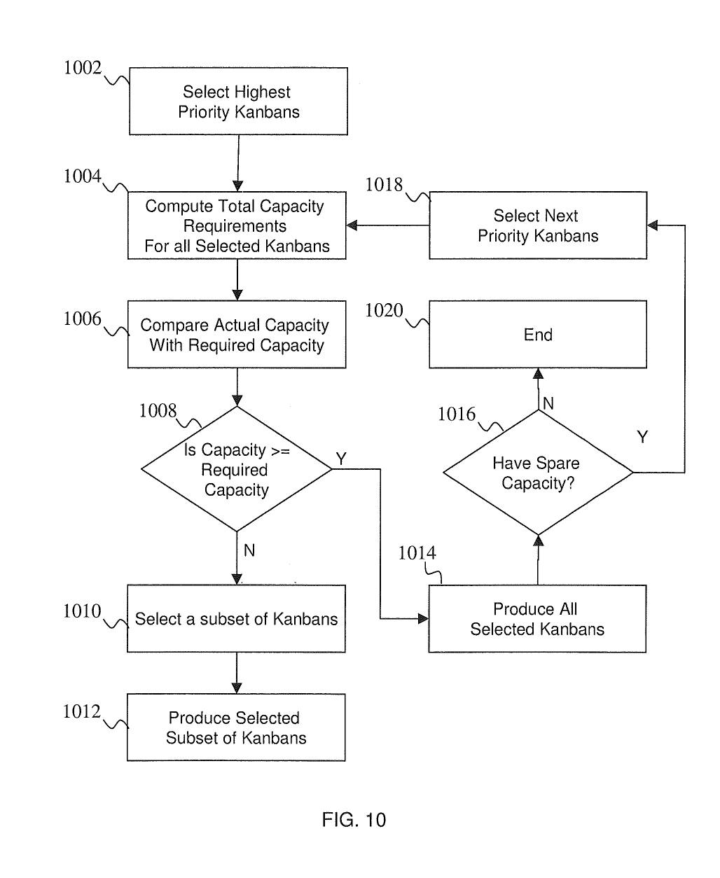

FIG. 10 illustrates a process flow for managing excess demand in an embodiment. In one embodiment, the process flow of FIG. 10 is executed by the capacity manager module 210 of FIG. 2. At block 1002 the capacity manager module 210 selects all of the kanbans from the highest priority queue from the kanban queue manager 208. At block 1004 the capacity manager module 210 computes the total actual capacity of the production environment. At block 1006 the capacity manager module 210 compares the actual capacity of the production environment with the capacity requirements of the selected kanbans. At block 1008, if the actual capacity is not sufficient to produce all of the selected kanbans, a subset of kanbans is chosen from the selected kanbans such that the capacity required by the subset is less than or equal to the actual capacity of the production environment at block 1010.

In one embodiment, a subset of kanbans is chosen at random from the selected kanbans. In another embodiment, the subset is chosen from the selected kanbans based on the length of time the kanban has been in the queue. For example, the kanbans are ordered in the queue by how long they have been in the queue, and kanbans that have been in the queue the longest are chosen one at a time until the actual capacity of the production environment has been exhausted. In yet another embodiment, the kanbans are analyzed and selected to maximize capacity. For example, assuming a production capacity of 6 units, and the queue contains 3 kanbans, the first requiring 3 units of capacity, the second requiring 2 units of capacity, and the third requiring 3 units of capacity, the capacity manager module 210 would select the first and third kanbans in order to use up all available capacity. In additional embodiments, two or more the previous embodiments for choosing a subset of kanbans are combined in order to choose a subset of kanbans to produce.

Returning to block 1010 of FIG. 10, once a subset of kanbans has been selected, the kanbans are produced at block 1012. Returning to block 1008, if there is sufficient actual capacity in the production environment to produce all of the selected kanbans, at block 1014 all of the selected kanbans are accepted for production. At block 1016 if the production environment has excess capacity after producing the selected kanbans, the next highest priority level of kanbans is selected at block 1018, and the process begins again at block 1004. Returning to block 1016, if there is no excess capacity after producing the selected kanbans, the process ends at block 1020. In another embodiment, if excess capacity is too small to be utilized by any kanban within the currently highest-priority, non-empty queue, at block 1010 subsequent, lower-priority queues are searched for a set of Kanbans that will maximize the utilization of the remaining capacity.

In a Lean environment there exist many production steps. Therefore, in one embodiment, a rule is put in place for the production and propagation manager module 212 that controls the propagation of replenishment orders derived from the demand (in form of netting stock and demand and by considering replenishment restrictions like kanban sizes, capacity constraints) to the supplier 215, which ultimately supplies the supermarket 204. Thereby, the production and propagation manager module 212 operates on replenishment signals that incorporate stochastic influences on the demand, the lead time, the yield factor, and the BOM factors, for example. The advantage is that more realistic forecasts are generated for the suppliers 214 by only looking at the approved kanbans from the supermarket 204.

In one embodiment, the propagation of the demand (represented by the kanbans in the production queues) considers only kanbans that have been approved by the capacity manager module 210 according to the process flow described above with regard to FIG. 10.

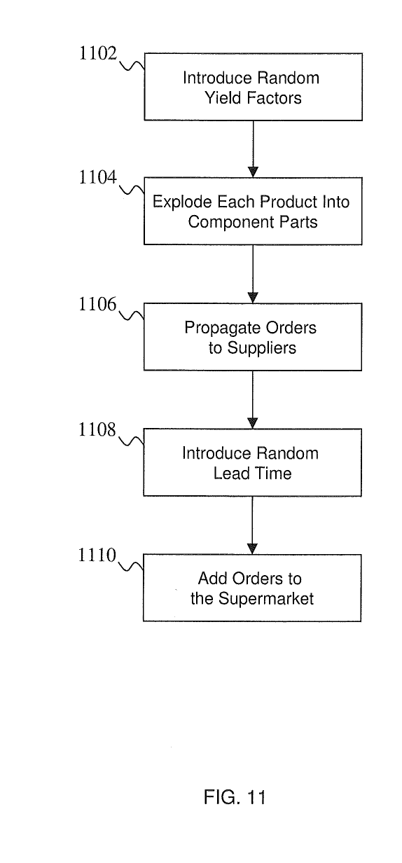

FIG. 11 illustrates a propagation of kanbans from the capacity manager via the production and propagation manager module 212 to the supplier 214 in an exemplary embodiment. At block 1102 the approved kanbans for a product A are exposed to random yield factors and define the production signal, which introduces the yield factors, via random numbers according to the given yield factor and yield fluctuation. At block 1104 the production signal is translated into the components of A that have to be supplied by the supplier 214 which could be a preceding production step. This is done according to the BOM (i.e. a BOM explosion). For example, in an embodiment, a wafer with 1000 chips has a varying number of “good” chips. If yield is 95% then 950 chips are good on average per wafer. In an embodiment, BOM quantities follow an average and a deviation, as well. For example a component C is built out of 200 chips A and 300 chips B. During the manufacturing process of component C 1% of A and 2% of B are broken (i.e. a 99% and 98% yield respectively). This leads to a distribution for the BOM explosion with 202 of component A +/−a fluctuation factor and 306 of component B +/−a fluctuation factor.

At block 1106 required parts orders derived from the BOM explosion and yield factors are sent to the one or more suppliers 214 for fulfillment. At block 1108 random lead-time is incorporated by drawing the lead-time according to the given lead-time distribution for the components. This lead-time varies based on the arrival time of the approved Kanbans for product A and the required lead time for the components from the suppliers 214. In an embodiment, the lead-time includes time introduced by quality assurance processes, machine disruptions and maintenance, demand for part numbers that share the same resource on other factors that affect the capacity and total production time of a part number as is known in the art. Additional factors may introduce variable delay such as disruptions on the transportation route from the supplier which affect the supply lead time. Processing time may vary as well based on skill level of the operators producing the parts, their reaction time, and other random factors as are known in the art. At block 1110, once the lead time has passed, the orders are added to the inventory of the supermarket 204.

Modern production processes include the production of complex bundles of products. Therefore, the capacity manager also has to be able to cover the approval of Kanbans that have interrelations between each other.

In an additional embodiment, the capacity manager module 210 considers complex production processes like product bundles or co-products, as well as individual products. In an embodiment, factors such as chip yields, and the number of additional computer components produced on a single wafer are factored into the kanban creation process. In one embodiment, a kanban is approved if and only if there is enough capacity to approve all Kanbans simultaneously that belong to one product bundle.

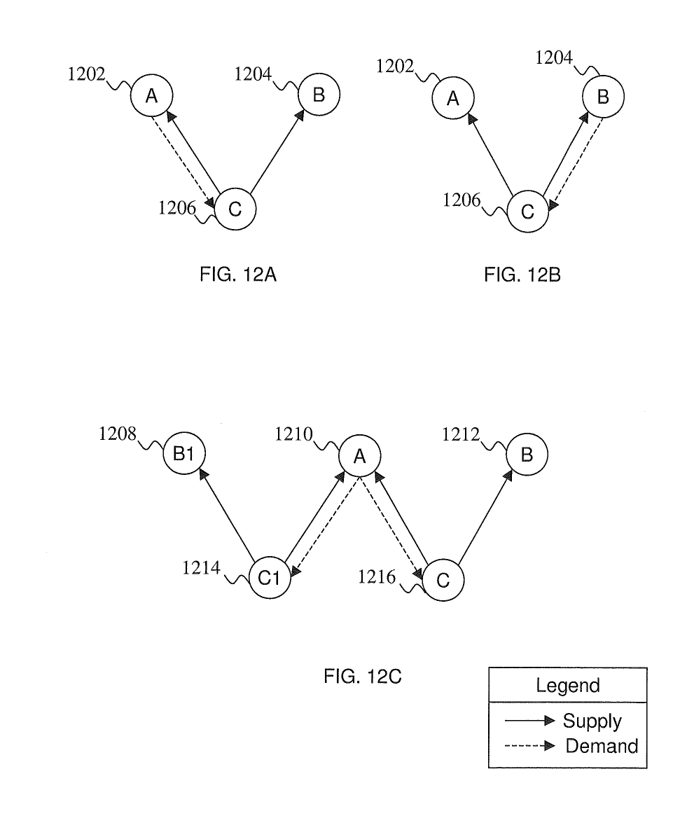

FIG. 12A illustrates demand and supply for orders of product bundles or co-products in an embodiment. Demand for product A 1202 triggers demand (shown as a dashed line) for supply of product C 1206. In an embodiment, product C 1206 is a wafer, which contains both product A 1202 and product B 1204. Therefore the demand for product A 1202 creates an additional supply of product B 1204 even though there is no demand for product B 1204.

FIG. 12B illustrates demand and supply for orders of product bundles or co-products in an additional embodiment. Demand for product B 1204 triggers demand (shown as a dashed line) for supply (shown as a solid line) of product C 1206. In an embodiment, product C 1206 is a wafer, which contains both product A 1202 and product B 1204. Therefore the demand for product B 1204 creates an additional supply of product A 1202 even though there is no demand for product A 1202.

FIG. 12C illustrates demand and supply for orders of more complex product bundles or co-products in a further embodiment. In this embodiment, product A 1210 needs components from wafers C1 1214 and wafer C2 1216. As in FIGS. 12A and 12B, demand for product A 1210 will generate a supply of product B 1212 which is created on wafer C 1216, and, additionally, produces a supply of product B1 1208 which is created on wafer 1214 even though there is no demand for either of product B1 1208 or B 1212, this is called multi-sourcing. In additional embodiments, product A 1210 may be produced by either of product C1 1214 or product C 1216. Therefore, demand for product A 1210 will produce either a supply for product B1 1208, or product B 1212.

As illustrated in FIGS. 12A-12C, complex interrelations between products in product bundles can result changes to supply and inventory of products that are not currently in demand, may also incorporate additional lead time variation based on the product bundle dependencies.

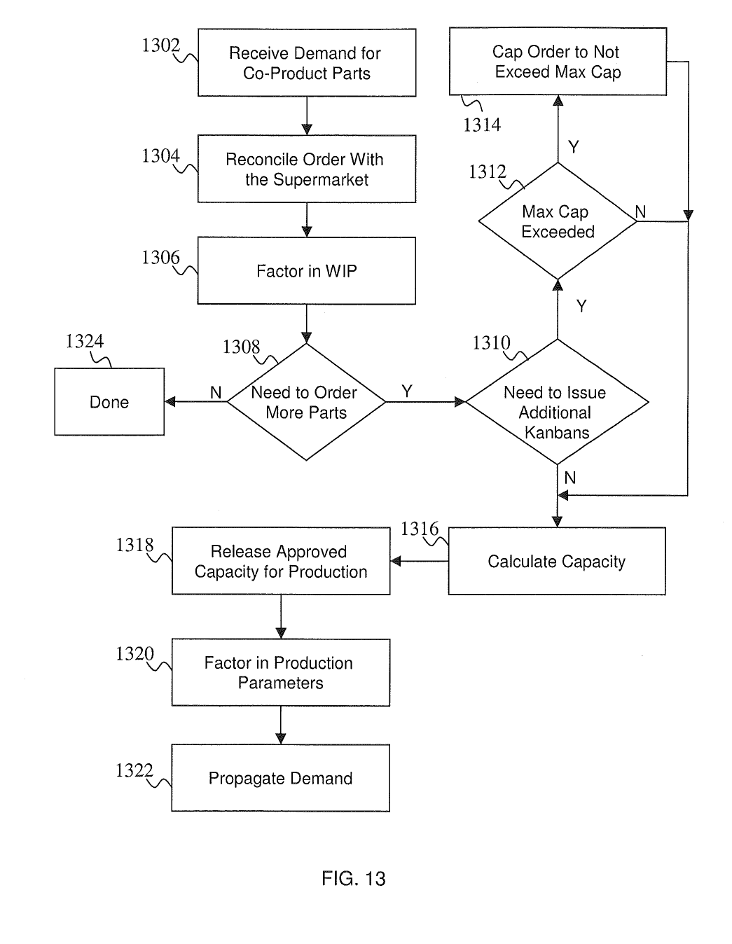

FIG. 13 illustrates a process flow for orders comprising product bundles or co-products in an embodiment. In one embodiment, the process flow of FIG. 13 is executed on the host system 102. At block 1302, demand for a product that is part of a co-product or product bundle is received at the supermarket 204. At block 1304, the WIP is added to the physical stock (i.e. inventory), and demand for the product is compared to the inventory in the supermarket. The supermarket 204 calculates the virtual inventory by adding together the actual inventory with the open orders. In an embodiment, open orders are orders that have been fulfilled and are in the delivery stream. At block 1308, if the virtual stock is above the first reorder point, the order is processed from inventory, no additional kanbans are created and processing ends at block 1324. In one embodiment, if the virtual stock is below the first reorder point, a replenishment signal is issued. In an additional embodiment, reorder points are compared to the physical stock on hand, the expected virtual or physical stock at time T, or other indicators of stock levels as is known in the art. In one embodiment, once the replenishment signal is issued, the virtual stock of the co-product is updated and the co-product will be stocked even if there has been no demand (i.e. the stocked is pushed in contrast to pulled). The addition of the co-product to the virtual stock will prevent any future additional replenishment signals for the co-product part.

At block 1310, the replenishment signal is compared to the outstanding kanbans for the part that has been ordered. In one embodiment, if the stock level is below the reorder point (positive “gap to ROP”) and the gap to ROP is higher than the number of kanbans on hand times the kanban quantity then only the number of kanbans on hand are issued.

At block 1312, the issued kanbans are checked against the maximum capacity for a given part number in the kanban. At block 1314, if the kanbans would result in an order that exceeds the maximum assigned capacity to produce it, the kanbans are capped so that the order does not exceed capacity for any of the parts associated with the kanban, and processing continues at block 1316. Returning to block 1312, if the max capacity is not exceeded, processing continues at block 1316. Returning to block 1310, if no additional kanbans are needed, the kanbans on hand are processed.

At block 1316, the replenishment signal for the entire group of parts is processed as a single order, and checked against capacity constraints. In one embodiment, all part numbers in the group are processed as a group. In another embodiment, the capacity manager module 210 processes all orders and requests for capacity in the order cycle, and capacity is allocated to each individual part number (PN). In one embodiment, unapproved capacity requests are tracked as part of a backlog. This backlog is processed on a first in first out (FIFO) manner. In one embodiment, additional kanbans, for example from a lower-priority queue, are scheduled to be processed if the capacity manager module 210 determines that excess capacity exists even after all of the orders have been accounted for.

At block 1318, once the capacity manager module 210 has allocated the capacity, the approved kanbans are released for production. At block 1320 the production takes place and production factors which affect the number of units that need to be produced, such as the yield and the yield variability are considered.

At block 1322, the production quantity is propagated to one or more of the suppliers 214 according to the BOM. In one embodiment, the production quantity corresponds to demand that is not accounted for based on WIP plus available physical stock and that has been approved for production. Included in the replenishment order are factors that impact yield and yield variability, and the quantity and its fluctuation of items in the BOM.

Technical effects and benefits improvements in both maximizing capacity of a production environment while smoothing out demand peaks and increasing customer SLAs. An additional benefit is the ability to incorporate priority kanbans, which provides for an emergency build ahead strategy. Yet another benefit is the ability to factor in co-product capacity constraint requirements, and additional output into future and current order processing.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A computer implemented method for managing production in a multi kanban environment, the method comprising:
setting, on a computer, a plurality of reorder points for a plurality of products, the plurality of reorder points comprising a first reorder point and a second reorder point, the second reorder point greater than the first reorder point;
determining, on the computer, demand for one or more of the plurality of products over a plurality of time periods;
determining, on the computer, an inventory level of the one or more of the plurality of products over the plurality of time periods in response to determining the demand;
issuing, on the computer, one or more normal kanbans for one or more of the plurality of time periods in response to determining that the inventory level of one or more of the plurality of products is below the first reorder point, the one or more of the plurality of time periods including a current time period;
issuing, on the computer, one or more build ahead kanbans for the one or more of the plurality of time periods in response to determining that the inventory level of one or more of the plurality of products is below the second reorder point but above the first reorder point;
approving, on the computer, for production in the current time period the one or more normal kanbans issued for the current time period;
determining, on the computer, if excess capacity exists to produce additional kanbans;
approving, on the computer, for production in the current time period one or more of the one or more build ahead kanbans in response to determining that excess capacity exists.

2. The method of claim 1, wherein the approved normal kanbans are produced prior to the approved build ahead kanbans.

3. The method of claim 2, wherein the plurality of reorder points further comprises a third reorder point, the third reorder point less then the first reorder point and further comprising:
issuing one or more emergency kanbans in response to determining that the inventory level of one or more of the plurality of products is below the third reorder point;
wherein the one or more emergency kanbans are produced prior to the one or more normal kanbans and the one or more build ahead kanbans.

4. The method of claim 1 wherein the second reorder point is set equal to the first reorder point.

5. The method of claim 1, where the determining of the inventory level comprises:
accumulating actual inventory, virtual inventory, and work in progress into a cumulative inventory;
accumulating actual product demand and anticipated product demand over each of the one or more of the plurality of time periods in the plurality of time periods into a cumulative product demand; and
determining inventory levels over each of the plurality of time periods by comparing the cumulative inventory with the cumulative product demand.

6. The method of claim 1, wherein the determining of excess capacity comprises determining one or more of:
product lead times;
current higher priority kanbans;
work in progress;
emergency kanbans;
yield factors; and
production time.

7. The method of claim 1, wherein only approved kanbans are produced.

8. The method of claim 1, wherein the plurality of reorder points are set based on one or more of:
product lead times;
yield factors;
production time;
product bundle components;
a bill of material for one or more of the plurality of products; and
capacity.

9. A system for managing production in a multi kanban environment comprising:
a modeler module for setting a plurality of reorder points for a plurality of products, the plurality of reorder points comprising a first reorder point and a second reorder point, the second reorder point greater than the first reorder point; determining demand for one or more of the plurality of products over a plurality of time periods; determining an inventory level of the one or more of the plurality of products over the plurality of time periods in response to determining the demand; issuing one or more normal kanbans for one or more of the plurality of time periods in response to determining that the inventory level of one or more of the plurality of products is below the first reorder point, the one or more of the plurality of time periods including a current time period; and issuing one or more build ahead kanbans for the one or more of the plurality of time periods in response to determining that the inventory level of one or more of the plurality of products is below the second reorder point but above the first reorder point; and
a capacity manager module communicatively coupled to the modeler module for approving for production in the current time period the one or more normal kanbans issued for the current time period; determining if excess capacity exists to produce additional kanbans; and approving for production in the current time period one or more of the one or more build ahead kanbans in response to determining that excess capacity exists.

10. The system of claim 9, wherein the approved normal kanbans are produced prior to the approved build ahead kanbans.

11. The system of claim 10, wherein the plurality of reorder points further comprises a third reorder point, the third reorder point less then the first reorder point and further comprising:
issuing one or more emergency kanbans in response to determining that the inventory level of one or more of the plurality of products is below the third reorder point;
wherein the one or more emergency kanbans are produced prior to the one or more normal kanbans and the one or more build ahead kanbans.

12. The system of claim 9, wherein the second reorder point is set equal to the first reorder point.

13. The system of claim 9, where the determining of the inventory level comprises:
accumulating actual inventory, virtual inventory, and work in progress into a cumulative inventory;
accumulating actual product demand and anticipated product demand over each of the one or more of the plurality of time periods in the plurality of time periods into a cumulative product demand; and
determining inventory levels over each of the plurality of time periods by comparing the cumulative inventory with the cumulative product demand.

14. The system of claim 9, wherein the determining of excess capacity comprises determining one or more of:
product lead times;
current higher priority kanbans;
work in progress;
emergency kanbans;
yield factors; and
production time.

15. The system of claim 9, wherein only approved kanbans are produced.

16. The system of claim 9, wherein the plurality of reorder points are set based on one or more of: product lead times;
yield factors;
production time;
product bundle components;
a bill of material for one or more of the plurality of products; and
capacity.

17. A computer program product for managing production in a multi kanban environment, the computer program product comprising:
a tangible storage medium readable by a processing circuit and storing instructions for performing a method comprising:
setting, on a computer, a plurality of reorder points for a plurality of products, the plurality of reorder points comprising a first reorder point and a second reorder point, the second reorder point greater than the first reorder point;
determining, on the computer, demand for one or more of the plurality of products over a plurality of time periods;
determining, on the computer, an inventory level of the one or more of the plurality of products over the plurality of time periods in response to determining the demand;
issuing, on the computer, one or more normal kanbans for one or more of the plurality of time periods in response to determining that the inventory level of one or more of the plurality of products is below the first reorder point, the one or more of the plurality of time periods including a current time period;
issuing, on the computer, one or more build ahead kanbans for the one or more of the plurality of time periods in response to determining that the inventory level of one or more of the plurality of products is below the second reorder point but above the first reorder point;
approving, on the computer, for production in the current time period the one or more normal kanbans issued for the current time period;
determining, on the computer, if excess capacity exists to produce additional kanbans;
approving, on the computer, for production in the current time period one or more of the one or more build ahead kanbans in response to determining that excess capacity exists.

18. The computer program product of claim 17, wherein the approved normal kanbans are produced prior to the approved build ahead kanbans.

19. The computer program product of claim 18, wherein the plurality of reorder points further comprises a third reorder point, the third reorder point less then the first reorder point and further comprising:
issuing one or more emergency kanbans in response to determining that the inventory level of one or more of the plurality of products is below the third reorder point;
wherein the one or more emergency kanbans are produced prior to the one or more normal kanbans and the one or more build ahead kanbans.

20. The computer program product of claim 17, wherein the second reorder point is set equal to the first reorder point.

21. The computer program product of claim 17, where the determining of the inventory level comprises:
accumulating actual inventory, virtual inventory, and work in progress into a cumulative inventory;
accumulating actual product demand and anticipated product demand over each of the one or more of the plurality of time periods in the plurality of time periods into a cumulative product demand; and
determining inventory levels over each of the plurality of time periods by comparing the cumulative inventory with the cumulative product demand.

22. The computer program product of claim 17, wherein the determining of excess capacity comprises determining one or more of:
product lead times;
current higher priority kanbans;
work in progress;
emergency kanbans;
yield factors; and
production time.

23. The computer program product of claim 17, wherein only approved kanbans are produced.

24. The computer program product of claim 17, wherein the plurality of reorder points are set based on one or more of:
product lead times;
yield factors;
production time;
product bundle components;
a bill of material for one or more of the plurality of products; and
capacity.
